(19) United States
(12) Patent Application Publication
(10) Pub. No.: US 2017/0045622 A1
(43) Pub. Date: Feb. 16, 2017

(54) ELECTRONIC APPARATUS, PHYSICAL ACTIVITY INFORMATION PRESENTING METHOD, AND RECORDING MEDIUM

(71) Applicant: Seiko Epson Corporation, Shinjuku-ku (JP)

(72) Inventor: Kazumi MATSUMOTO, Shiojiri-shi (JP)

(21) Appl. No.: 15/234,731

(22) Filed: Aug. 11, 2016

(30) Foreign Application Priority Data
Aug. 12, 2015 (JP) 2015-159412

(51) Int. Cl. G01S 19/19; A63B 24/00

(52) U.S. Cl. CPC G01S 19/19; A63B 24/0062; A63B 24/0021; A63B 2220/17; A63B 2220/22; A63B 2244/19; A63B 2225/50; A63B 2220/836; A63B 2024/0025

(57) ABSTRACT

An electronic apparatus includes a processing unit that presents either or both of indexes and evaluations regarding physical activity of a user causing a directional change by using movement direction information of the user calculated on the basis of a satellite signal.

### CROSS-REFERENCE TO RELATED APPLICATIONS

The entire disclosure of Japanese Patent Application No. 2015-159412, filed Aug. 12, 2015 is expressly incorporated by reference herein.

### BACKGROUND

1. Technical Field

The present invention relates to an electronic apparatus, a physical activity information presenting method, and a recording medium.

2. Related Art

Generally, an inertial sensor which can detect force working on the body or an attitude of the body is frequently mounted on an exercise analysis apparatus measuring a user's physical activity, and a global navigation satellite system (GNSS) device which can receive a satellite signal is frequently mounted on a navigation apparatus measuring a position or a movement path of a user (refer to JP-A-2014-240266 or the like).

Among apparatuses employing the inertial sensor and the GNSS device, there is an apparatus in which outputs from the GNSS device are used to correct outputs from the inertial sensor.

However, in a case where outputs from the GNSS device are used to measure physical activity, only a position or a movement path is used.

### SUMMARY

An advantage of some aspects of the invention is to provide an electronic apparatus, a physical activity information presenting method, and a recording medium, capable of effectively using a satellite signal for measuring physical activity of a user.

The invention can be implemented as the following forms or application examples.

### Application Example 1

An electronic apparatus according to this application example includes a processing unit that presents either or both of indexes and evaluations regarding physical activity of a user causing a directional change by using movement direction information of the user calculated on the basis of a satellite signal.

The processing unit uses the movement direction information based on the satellite signal in order to present either or both of the indexes and the evaluations. Therefore, the movement direction information among pieces of information obtained by using the satellite signal can be used to newly measure physical activity.

### Application Example 2

In the electronic apparatus according to the application example, the physical activity may include periodic body motion of the user.

According to this application example, the movement direction information based on the satellite signal can be used to present either or both of the indexes and the evaluations regarding the periodic body motion of the user.

### Application Example 3

In the electronic apparatus according to the application example, the periodic body motion may include at least one of walking and running performed by the user.

According to this application example, the movement direction information based on the satellite signal can be used to present either or both of the indexes and the evaluations regarding at least one of walking and running of the user.

### Application Example 4

In the electronic apparatus according to the application example, the indexes may include at least one of the number of steps and a stride of the user.

According to this application example, the movement direction information based on the satellite signal can be used to present at least one of the number of steps and a stride of the user.

### Application Example 5

In the electronic apparatus according to the application example, the movement direction information may include a vertical component of a movement direction of the user.

Vertical motion of the user's body is reflected in the vertical component of the movement direction of the user. Therefore, according to this application example, the movement direction information based on the satellite signal can be used to present either or both of the indexes and the evaluations regarding the vertical motion.

### Application Example 6

In the electronic apparatus according to the application example, the periodic body motion may include the user's turns when skiing.

According to this application example, the movement direction information based on the satellite signal can be used to present either or both of the indexes and the evaluations regarding the user's turns when skiing.

### Application Example 7

In the electronic apparatus according to the application example, the indexes may include at least one of the number of turns and a turn depth of the user.

According to this application example, the movement direction information based on the satellite signal can be used to present at least one of the number of turns and a turn depth of the user.

### Application Example 8

In the electronic apparatus according to the application example, the movement direction information may include a horizontal component of a movement direction of the user.

Horizontal motion of the user's body is reflected in the horizontal component of the movement direction of the user. Therefore, according to this application example, the movement direction information based on the satellite signal can be used to present either or both of the indexes and the evaluations regarding the horizontal motion.

### Application Example 9

In the electronic apparatus according to the application example, the movement direction information may be calculated on the basis of a Doppler frequency of the satellite signal.

The movement direction information at a certain point can be obtained by using a Doppler frequency of a satellite signal received at the point. Therefore, if movement direction information is calculated by using a Doppler frequency, time required to calculate the movement direction information can be reduced compared with a case where positions are detected at two or more points, and the movement direction information is calculated by using a positional change.

### Application Example 10

In the electronic apparatus according to the application example, the electronic apparatus may be mounted on the user's body.

Therefore, the user can recognize either or both of the indexes and the evaluations even if the user does not hold the electronic apparatus with the hand thereof.

### Application Example 11

A physical activity information presenting method according to this application example includes presenting either or both of indexes and evaluations regarding physical activity of a user causing a directional change by using movement direction information of the user calculated on the basis of a satellite signal.

In the physical activity information presenting method, the movement direction information based on the satellite signal is used to present either or both of the indexes and the evaluations. Therefore, the movement direction information among pieces of information obtained by using the satellite signal can be used to newly measure physical activity.

### Application Example 12

A physical activity information presenting program according to this application example causes a computer to present either or both of indexes and evaluations regarding physical activity of a user causing a directional change by using movement direction information of the user calculated on the basis of a satellite signal.

In the physical activity information presenting program, the movement direction information based on the satellite signal is used to present either or both of the indexes and the evaluations. Therefore, the movement direction information among pieces of information obtained by using the satellite signal can be used to newly measure physical activity.

### BRIEF DESCRIPTION OF THE DRAWINGS

The invention will be described with reference to the accompanying drawings, wherein like numbers reference like elements.

FIG. 1 is a diagram illustrating an outline of an exercise analysis system according to a first embodiment.

FIG. 2 is a functional block diagram illustrating configuration examples of an exercise analysis apparatus and a display apparatus.

FIG. 3 is a functional block diagram illustrating configuration examples of a GPS unit and a processing unit in the first embodiment.

FIG. 4 is a diagram for explaining an example of a relationship between an advancing direction of a user and a direction vector.

FIG. 5 is a diagram for explaining a temporal change of a vertical component of the direction vector.

FIG. 6 is a flowchart illustrating examples of procedures of an exercise analysis process.

FIG. 7 is a flowchart illustrating examples of procedures of data processing.

FIG. 8 is a flowchart illustrating examples of procedures of a running detection process.

FIG. 9 is a diagram illustrating an example of a screen displayed during a user's running.

FIG. 10 is a diagram illustrating an example of a screen displayed after the user's running.

FIG. 11 is a functional block diagram illustrating configuration examples of a GPS unit and a processing unit in a second embodiment.

FIG. 12 is a diagram for explaining an example of a relationship between an advancing direction of a user and a direction vector.

FIG. 13 is a diagram for explaining a temporal change of an azimuth angle obtained on the basis of the direction vector.

### DESCRIPTION OF EXEMPLARY EMBODIMENTS

Hereinafter, preferred embodiments of the invention will be described in detail with reference to the drawings. The embodiments described below are not intended to improperly limit the configuration of the invention disclosed in the appended claims. It cannot be said that all constituent elements described below are essential constituent elements of the invention.

### 1. First Embodiment

### 1-1. Description of Exterior

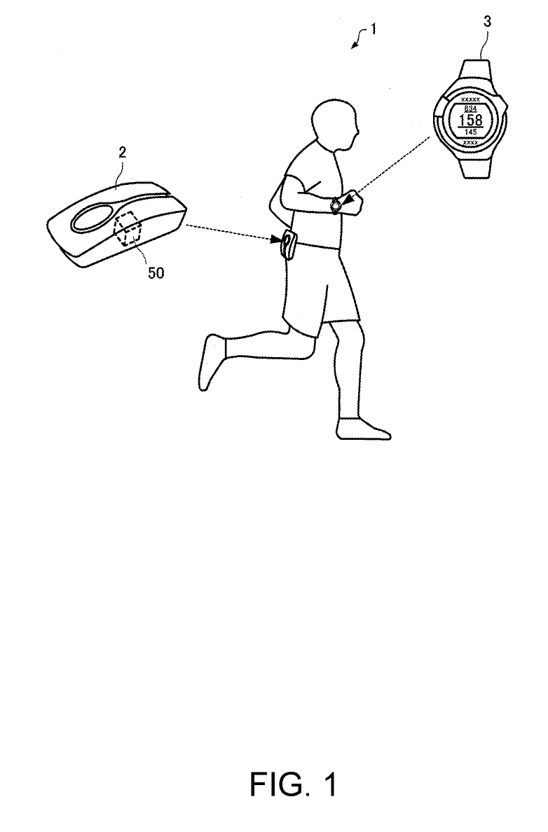

FIG. 1 is a diagram for explaining an outline of an exercise analysis system 1 according to a first embodiment. As illustrated in FIG. 1, the exercise analysis system 1 of the present embodiment includes an exercise analysis apparatus 2 (an example of an electronic apparatus) and a display apparatus 3. The exercise analysis apparatus 2 is mounted on a body part (for example, a right part, a left part, or a central part of the waist) of a user. The exercise analysis apparatus 2 has a global positioning system (GPS) unit 50 built thereinto, recognizes motion of the user in exercise (herein, running), computes velocity, a position, and the like, and analyzes the user's exercise so as to generate exercise analysis information (an example of an index or evaluation). The exercise analysis apparatus 2 transmits at least some of the generated exercise analysis information to the display apparatus 3.

The display apparatus 3 is a wrist type (wristwatch type) portable information apparatus and is mounted on the user's wrist or the like. However, the display apparatus 3 may be a portable information apparatus such as a head mounted display (HMD) or a smart phone. The user operates the display apparatus 3 so as to instruct the exercise analysis apparatus 2 to start or stop measurement (data processing or an exercise analysis process which will be described later) before starting running or during running. The display apparatus 3 transmits a command for instructing measurement to be started or stopped, to the exercise analysis apparatus 2.

If a command for starting measurement has been received, the exercise analysis apparatus 2 causes the GPS unit 50 to start measurement, and analyzes the user's exercise on the basis of a measurement result so as to generate exercise analysis information. The exercise analysis apparatus 2 transmits the generated exercise analysis information to the display apparatus 3. The display apparatus 3 receives the exercise analysis information, and presents the received exercise analysis information to the user in various forms such as text, graphics, sound, and vibration. The user can recognize the exercise analysis information via the display apparatus 3 during running.

Data communication between the exercise analysis apparatus 2 and the display apparatus 3 may be wireless communication or wired communication.

In the present embodiment, hereinafter, as an example, a detailed description will be made of a case where the exercise analysis apparatus 2 generates exercise analysis information regarding running of the user (an example of physical activity), but the exercise analysis system 1 of the present embodiment is also applicable to a case where exercise analysis information is generated in exercises other than running.

Coordinate systems necessary in the following description are defined.
Earth centered earth fixed frame (e frame): right handed three-dimensional orthogonal coordinates in which the center of the earth is set as an origin, and a z axis is taken so as to be parallel to the axis of the earth
Latitude longitude altitude frame (L frame): coordinates represented by three components such as polar coordinates (latitude and longitude) and altitude with the center of the earth as the origin

### 1-2. Outline of GPS

A GPS satellite which is one kind of positioning satellite rotates around a predetermined orbit above the earth, and transmits an electric wave signal (hereinafter, also referred to as a “GPS satellite signal”) (an example of a satellite signal) in which a navigation message is superimposed on an electric wave (L1 wave) of 1.57542 GHz, to the earth.

Currently, there are about thirty GPS satellites, and, in order to indentify a GPS satellite which transmits a GPS satellite signal, each GPS satellite superimposes a unique pattern of 1023 chips (a cycle of 1 ms) called a coarse/acquisition code (C/A code) on the GPS satellite signal. Each chip of the C/A code has either +1 or −1, and thus the C/A code appears to have a random pattern. In the GPS, all of the GPS satellites employ a code division multiple access (CDMA) method in which satellite signals with the same frequency are transmitted by using different C/A codes, and thus it is possible to detect a C/A code superimposed on a GPS satellite signal by correlating the GPS satellite signal with a pattern of each C/A code.

The GPS satellite has an atomic clock mounted therein, and thus a GPS satellite signal includes considerably accurate time information which is measured by the atomic clock. A slight time error in the atomic clock mounted in each GPS satellite is measured by a control segment (not illustrated) on the earth, and the navigation message also includes time correction data for correcting the time error.

The GPS unit 50 performs a process of receiving a GPS satellite signal from each GPS satellite so as to demodulate a navigation message and correcting internal time by using time information and time correction data included in the navigation message, or a process of performing positioning computation by using the time information and orbital information (ephemeris data) included in the navigation message.

In a case of calculating a two-dimensional position (x,y), the GPS unit 50 performs a process of setting an internal time error t as an unknown quantity in addition to x and y, setting up three or more simultaneous equations by using time information and orbital information (ephemeris data) included in respective navigation messages from three or more GPS satellites, and obtaining a solution thereof Similarly, in a case of calculating a three-dimensional position (x,y,z), the GPS unit 50 performs a process of setting an internal time error t as an unknown quantity in addition to x, y and z, setting up four or more simultaneous equations by using time information and orbital information (ephemeris data) included in respective navigation messages from four or more GPS satellites, and obtaining a solution thereof

In a case where valid ephemeris data is not held, such as the time of power being supplied, first, the GPS unit 50 starts a process of searching for a GPS satellite which can be captured, that is, a GPS satellite from which a navigation message can be demodulated (cold start). In a case of the cold start, the GPS unit 50 tries to acquire ephemeris data for all of the GPS satellites, and 12.5 minutes are required to store the acquired ephemeris data. Three-dimensional positioning computation may be performed at the time of obtaining ephemeris data of four or more GPS satellites, but several minutes are required to obtain a result thereof

In contrast, in a case where the GPS unit 50 does not hold valid ephemeris data but holds valid almanac data, such as a case where the GPS unit 50 returns from a standby mode, a GPS satellite which can be captured can be estimated, and thus it is possible to reduce time required to obtain a result of positioning computation (warm start).

If four or more valid ephemeris data items are held, the GPS unit 50 can immediately start positioning computation (hot start).

1-3. System configuration

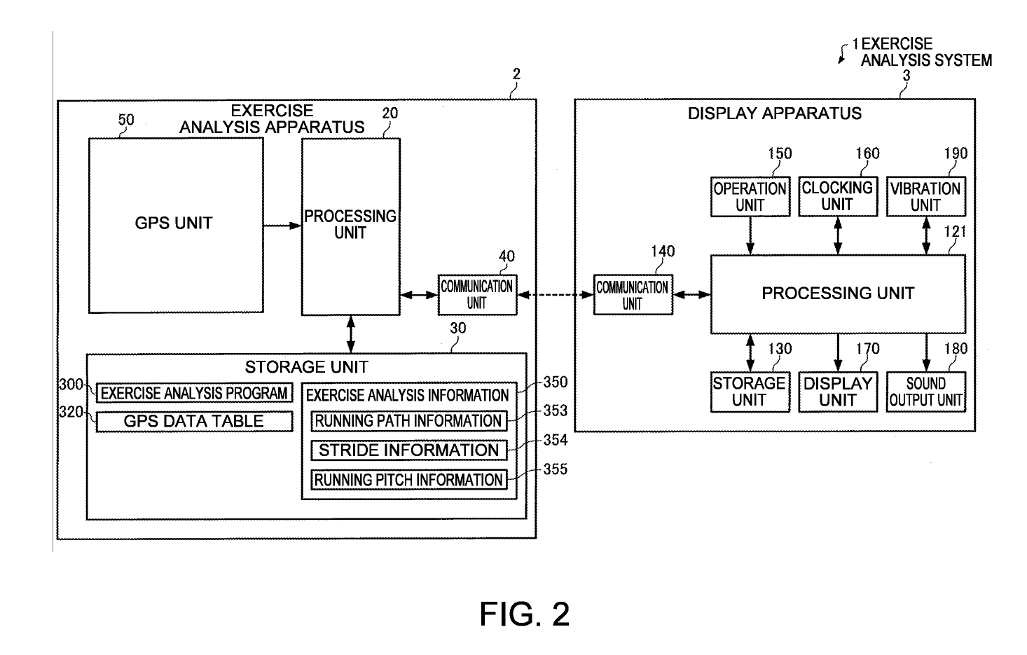

FIG. 2 is a functional block diagram illustrating configuration examples of the exercise analysis apparatus 2 and the display apparatus 3. As illustrated in FIG. 2, the exercise analysis apparatus 2 includes a processing unit (an example of a computer) 20, a storage unit 30, a communication unit 40, and the global positioning system (GPS) unit 50. However, the exercise analysis apparatus 2 of the present embodiment may have a configuration in which some of the constituent elements are deleted or changed, or other constituent elements may be added thereto.

The GPS unit 50 receives a GPS satellite signal which is transmitted from a GPS satellite, performs positioning computation by using the GPS satellite signal so as to calculate a position of the user and velocity vectors, and outputs GPS data in which time information or the like is added to the calculated results to the processing unit 20. Information regarding velocity vector (velocity vector information) is expressed by a combination of information regarding a direction vector (direction vector information) and information regarding a velocity (velocity information).

Here, a cycle of positioning computation in the GPS unit 50 is preferably shorter than a running cycle of the user. This is because, in the present embodiment, an index such as a running cycle of the user is computed on the basis of at least some GPS data (for example, direction vector information) obtained through positioning computation. Specifically, the number of positioning computations per second is preferably higher than at least 1 Hz, and, assuming that the number of steps per second in normal running is 3 Hz, the number of positioning computation per second is preferably set to 6 Hz or higher which is twice or more the number of steps per second. Therefore, the number of positioning computation per second is assumed to be set to any value within, for example, a range of 1 Hz to 20 Hz depending on an application (the kind of exercise) of the exercise analysis apparatus 2. Relationships between various applications and the number of positioning computation per unit time will be described later.

The processing unit 20 is constituted of, for example, a central processing unit (CPU), a digital signal processor (DSP), or an application specific integrated circuit (ASIC), and performs various calculation processes or control processes according to various programs stored in the storage unit 30. Particularly, the processing unit 20 receives GPS data from the GPS unit 50, so as to calculate a velocity, a position, and the like of the user by using the data. The processing unit 20 performs various calculation processes by using the calculated information so as to analyze exercise of the user and to generate various pieces of exercise analysis information. The processing unit 20 transmits the generated pieces of exercise analysis information (output information during running or output information after running which will be described later) to the display apparatus 3 via the communication unit 40, and the display apparatus 3 outputs the received exercise analysis information in a form of text, an image, sound, vibration, or the like.

The storage unit 30 is constituted of, for example, recording media including various IC memories such as a read only memory (ROM), a flash ROM, and a random access memory (RAM), a hard disk, and a memory card.

The storage unit 30 stores an exercise analysis program (an example of a physical activity information presenting program) 300 which is read by the processing unit 20 and is used to perform an exercise analysis process (refer to FIG. 6). The storage unit 30 stores, a GPS data table 320, exercise analysis information 350, and the like.

The GPS data table 320 is a table in which GPS data items (time information, position information, velocity vector information, and the like) received from the GPS unit 50 by the processing unit 20 are arranged in a time series. If the processing unit 20 starts measurement, the GPS data table 320 is updated by adding new GPS data thereto whenever the GPS data is acquired.

The exercise analysis information 350 is various pieces of information regarding exercise of the user, and includes running path information 353, stride information 354, running pitch information 355, and the like generated by the processing unit 20.

The communication unit 40 performs data communication with a communication unit 140 of the display apparatus 3, and performs a process of receiving exercise analysis information (including output information during running and output information after running) generated by the processing unit 20 and transmitting the exercise analysis information to the display apparatus 3, a process of receiving a command (a command for starting or stopping measurement, or the like) transmitted from the display apparatus 3 and sending the command to the processing unit 20, and the like.

The display apparatus 3 includes a processing unit 121, a storage unit 130, the communication unit 140, an operation unit 150, a clocking unit 160, a display unit 170, a sound output unit 180, and a vibration unit 190. However, the display apparatus 3 of the present embodiment may have a configuration in which some of the constituent elements are deleted or changed, or other constituent elements may be added thereto.

The processing unit 121 performs various calculation processes or control processes according to a program stored in the storage unit 130. For example, the processing unit 121 performs various processes (a process of sending a command for starting or stopping measurement to the communication unit 140, a process of performing display or outputting sound corresponding to operation data, and the like) corresponding to the operation data received from the operation unit 150; a process of receiving output information during running or output information after running from the communication unit 140 and sending text data or image data corresponding to the output information during running or the output information after running to the display unit 170; a process of sending sound data corresponding to the output information during running or the output information after running to the sound output unit 180; and a process of sending vibration data corresponding to the output information during running to the vibration unit 190. The processing unit 121 performs a process of generating time image data corresponding to time information received from the clocking unit 160 and sending the time image data to the display unit 170, and the like.

The storage unit 130 is constituted of various IC memories such as a ROM which stores a program or data required for the processing unit 121 to perform various processes, and a RAM serving as a work area of the processing unit 121.

The communication unit 140 performs data communication with the communication unit 40 of the exercise analysis apparatus 2, and performs a process of receiving a command (a command for starting or stopping measurement, or the like) corresponding to operation data from the processing unit 121 and transmitting the command to the exercise analysis apparatus 2, a process of receiving exercise output information during running or output information after running transmitted from the exercise analysis apparatus 2 and sending the information to the processing unit 121, and the like.

The operation unit 150 performs a process of acquiring operation data (operation data such as starting or stopping of measurement or selection of display content) from the user and sending the operation data to the processing unit 121. The operation unit 150 may be, for example, a touch panel type display, a button, a key, or a microphone.

The clocking unit 160 performs a process of generating time information such as year, month, day, hour, minute, and second. The clocking unit 160 is implemented by, for example, a real time clock (RTC) IC.

The display unit 170 displays image data or text data sent from the processing unit 121 as text, a graph, a table, animation, or other images. The display unit 170 is implemented by, for example, a display such as a liquid crystal display (LCD), an organic electroluminescent (EL) display, or an electrophoretic display (EPD), and may be a touch panel type display. A single touch panel type display may realize functions of the operation unit 150 and the display unit 170.

The sound output unit 180 outputs sound data sent from the processing unit 121 as a sound such as a voice or a buzzer sound. The sound output unit 180 is implemented by, for example, a speaker or a buzzer.

The vibration unit 190 vibrates in response to vibration data sent from the processing unit 121. This vibration is transmitted to the display apparatus 3, and the user wearing the display apparatus 3 can feel the vibration. The vibration unit 190 is implemented by, for example, a vibration motor.

### 1-4. Flow of Principal Data

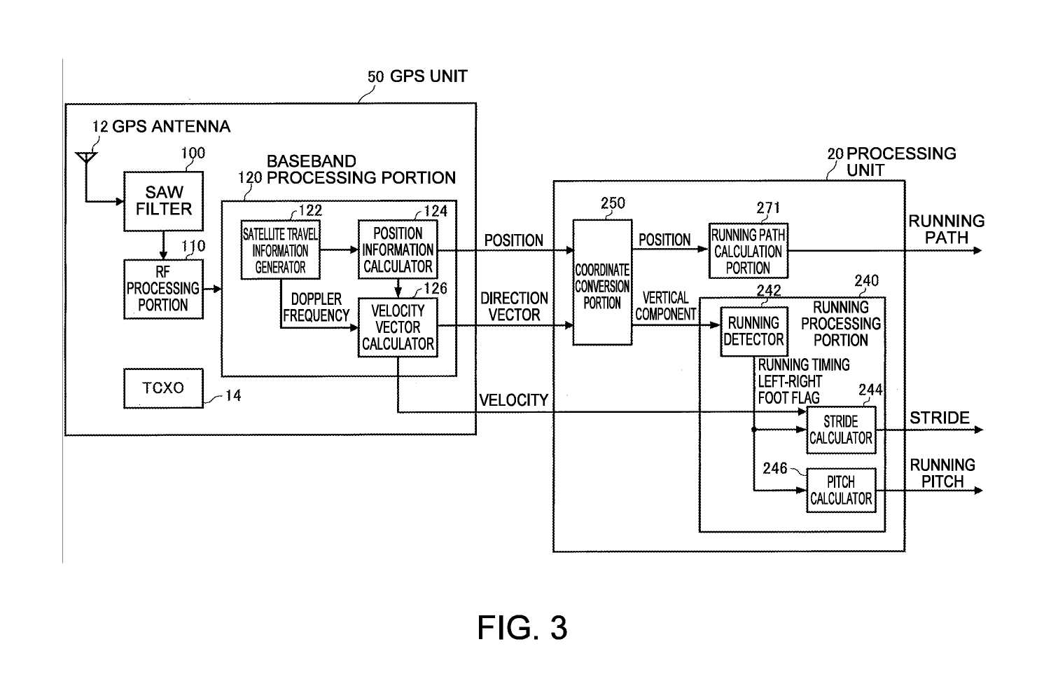

FIG. 3 is a diagram for explaining a flow of data in the GPS unit 50 and the processing unit 20.

The GPS unit 50 is configured to include a GPS antenna 12, a temperature compensated crystal oscillator (TCXO) 14, a surface acoustic wave (SAW) filter 100, an RF processing portion 110, and a baseband processing portion 120. The GPS unit 50 of the present embodiment may have a configuration in which some of the constituent elements are deleted, or other constituent elements may be added thereto.

The SAW filter 100 performs a process of extracting a GPS satellite signal from an electric wave received by the GPS antenna 12. In other words, the SAW filter 100 is formed of a band-pass filter through which a signal with a 1.5 GHz band passes.

The RF processing portion 110 down-converts the GPS satellite signal extracted by the SAW filter 100 into a signal (IF signal) with an intermediate frequency band (for example, several MHz), AID-converts the signal, and then outputs the converted signal to the baseband processing portion 120.

The baseband processing portion 120, which demodulates a baseband signal from the IF signal output from the RF processing portion 110, performs various processes on the demodulated baseband signal, and is configured to include a satellite travel information generator 122, a position information calculator 124, and a velocity vector calculator 126. The baseband processing portion 120 of the present embodiment may have a configuration in which some of the constituent elements are deleted, or other constituent elements may be added thereto.

The satellite travel information generator 122 performs a process of generating satellite travel information regarding travel of a GPS satellite on the basis of a baseband signal.

Specifically, first, the satellite travel information generator 122 performs a satellite search process of searching for a GPS satellite which can be captured. More specifically, the satellite travel information generator 122 generates a local code with the same pattern as that of each C/A code, and performs a process of correlating each C/A code included in the baseband signal with the local code. The satellite travel information generator 122 adjusts a local code generation timing so that a correlation value for each local code becomes the peak, and determines that synchronization with a GPS satellite related to the local code occurs (the GPS satellite is captured) when the correlation value becomes the threshold value or more. The satellite travel information generator 122 recognizes satellite identification information (for example, a satellite number) of the captured GPS satellite. The satellite travel information generator 122 can reduce processing time by performing the satellite search process on a plurality of (for example, twelve) satellites in parallel.

The satellite travel information generator 122 demodulates a navigation message from the baseband signal so as to acquire various pieces of information included in the navigation message. Specifically, the satellite travel information generator 122 mixes a local code with the same pattern as that of a C/A code of the captured GPS satellite with the baseband signal so as to demodulate the navigation message, and acquires orbital information (ephemeris data or almanac data), time information, or the like included in the navigation message.

The satellite travel information generator 122 acquires other information regarding the captured GPS satellite in the middle of processes such as the above-described correlation. The information includes, for example, information regarding the reception intensity of a GPS satellite signal for each GPS satellite and information regarding a Doppler frequency of the GPS satellite signal. The Doppler frequency reflects therein information regarding a difference between a carrier frequency of the GPS satellite signal and a reception frequency of the GPS satellite signal, that is, information regarding a relative velocity of the GPS satellite in a visual line direction of the exercise analysis apparatus 2. The “visual line direction” mentioned here is a direction of the GPS satellite viewed from the exercise analysis apparatus 2.

Therefore, for example, it is possible to calculate three-dimensional velocity vectors representing a movement direction in a space of the exercise analysis apparatus 2 on the basis of Doppler frequencies for four GPS satellites, orbital information for the four GPS satellites, and position information of the exercise analysis apparatus 2. Information (velocity vector information) regarding the three-dimensional velocity vectors is represented by a combination of information (direction vector information) (an example of movement direction information) regarding direction vectors which are unit vectors directed toward the same directions as those of the velocity vectors, and velocity information indicating the magnitudes of the velocity vectors.

In the above description, the number of GPS satellite signals is “four” greater than “three” in order to calculate velocity vectors regardless of a time error between each GPS satellite and the exercise analysis apparatus 2.

The position information calculator 124 performs positioning computation on the basis of the orbital information acquired by the satellite travel information generator 122, so as to acquire position information, and transmits the position information to the processing unit 20. Here, it is assumed that the position information transmitted from the position information calculator 124 to the processing unit 20 is expressed by the above-described e frame.

The velocity vector calculator 126 calculates velocity vectors of the exercise analysis apparatus 2 on the basis of the respective pieces of information such as the Doppler frequencies for a plurality of GPS satellites and the orbital information (ephemeris data or almanac data) acquired by the satellite travel information generator 122, and the position information calculated by the position information calculator 124. For example, the velocity vector calculator 126 uses respective pieces of information for four GPS satellites to calculate velocity vectors at the time of starting reception, and then uses respective pieces of information for GPS satellites of less than four to calculate velocity vectors. The velocity vector calculator 126 transmits calculated velocity vector information (a combination of direction vector information and velocity information) to the processing unit 20. Here, it is assumed that the direction vector information transmitted from the position information calculator 124 to the processing unit 20 is expressed by the above-described e frame.

As described above, the GPS data transmitted from the GPS unit 50 to the processing unit 20 includes the time information, the position information, the velocity vector information (the direction vector information and the velocity information), and the like. The processing unit 20 updates the GPS data table 320 by adding new GPS data thereto whenever the GPS data is acquired. The GPS data table 320 is referred to by the processing unit 20 as necessary.

The TCXO 14 generates clock signals for the RF processing portion 110 or the baseband processing portion 120.

The processing unit 20 is configured to include a coordinate conversion portion 250, a running path calculation portion 271, and a running processing portion 240. The processing unit 20 of the present embodiment may have a configuration in which some of the constituent elements are deleted, or other constituent elements may be added thereto.

The coordinate conversion portion 250 coordinate-converts the position information expressed by the e frame into position information expressed by the L frame. The coordinate conversion portion 250 coordinate-converts the direction vector information expressed by the e frame into direction vector information expressed by the L frame.

The running path calculation portion 271 calculates a running path of the user in the L frame by using the position information (and history of the position information) expressed by the L frame. Information regarding the calculated running path is written to the storage unit 30 as the running path information 353. The running path information 353 and other information written to the storage unit 30 are referred to by the processing unit 20 as necessary.

The running processing portion 240 includes a running detector 242, a stride calculator 244, and a pitch calculator 246.

The running detector 242 performs a process of detecting a running cycle of the user by using the direction vector information. In addition, “detection of a running cycle” mentioned here indicates detecting a predetermined timing within the running cycle. The predetermined timing may be a kicking timing, may be a landing timing, and may be a timing at which the user takes a predetermined attitude in a period of time from kicking to landing.

Typically, during running, an attitude of the user periodically changes (every two steps (two steps such as left and right steps)), a direction vector (indicated by the direction vector information) also periodically changes. Therefore, body motion due to running is an example of periodic body motion.

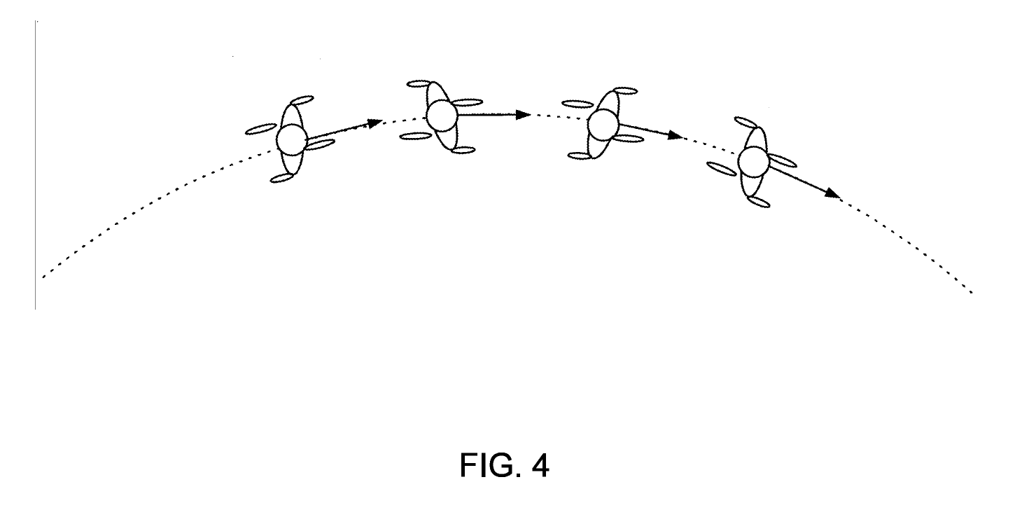

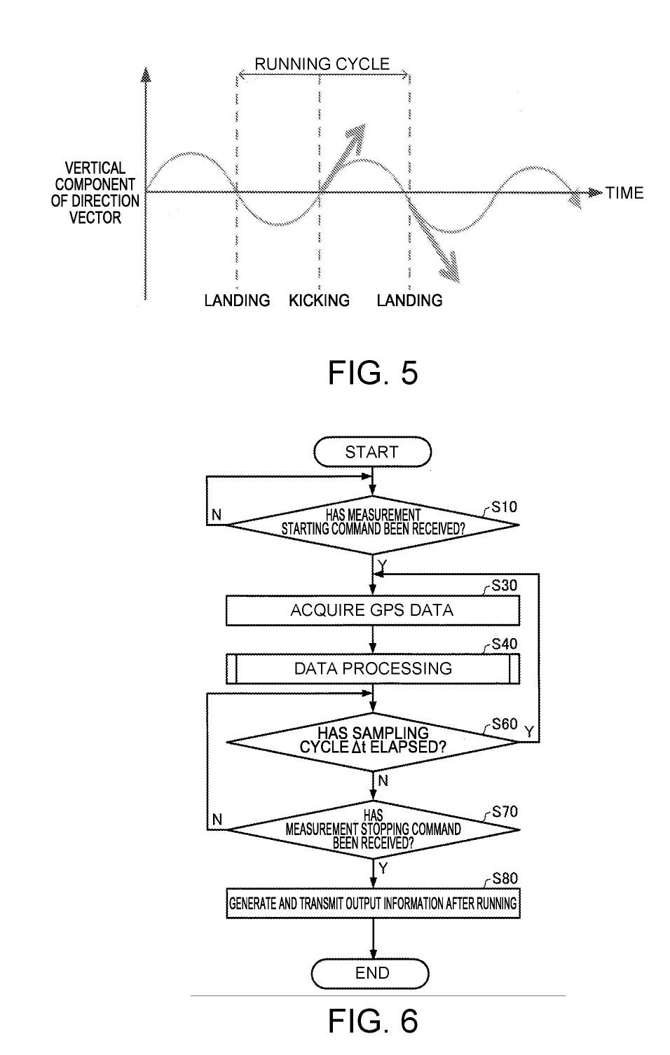

Here, when the direction vector is viewed from the right above of the user (from the top in a vertical direction), as illustrated in FIG. 4, the direction vector generally indicates the front side of the user (a direction in which the center of the user's body moves). In the present specification, the “vertical direction” is a direction along the direction in which the gravity acts, and, regarding upward and downward directions in the vertical direction, the direction in which the gravity acts is the downward direction. However, focusing on a vertical component of the direction vector (a vertical direction component of the direction vector), it can be seen that the vertical component periodically changes as illustrated in FIG. 5. In FIG. 5, a transverse axis expresses time, and a longitudinal axis expresses a vertical component of the direction vector. A cycle length of a temporal change in the vertical component is a period of time from landing of one foot of the user to landing of the other foot thereof.

Therefore, the vertical component of the direction vector reflects vertical motion of the user, and a period of time from the time at which the vertical component becomes the maximum value which is equal to or greater than a predetermined threshold value to the time at which the vertical component becomes the maximum value which is equal to or greater than the predetermined threshold value next corresponds to a period of time of one step. One step in a state in which the user takes a step forward with the right foot and one step in a state in which the user takes a step forward with the left foot are alternately taken in a repeated manner.

Therefore, the running detector 242 of the present embodiment alternately detects a running cycle of the right foot and a running cycle of the left foot whenever the vertical component of the direction vector becomes the maximum value which is equal to or greater than the predetermined threshold value. In other words, the running detector 242 outputs a timing signal indicating detection of the running cycle and a left-right foot flag (for example, an ON flag for the right foot, and an OFF flag for the left foot) indicating the corresponding running cycle.

For example, the running detector 242 differentiates the running cycle of the right foot and the running cycle of the left foot by using components (an azimuth angle of the direction vector, and the like) other than the vertical component of the direction vector. The azimuth angle of the direction vector is an angle formed between the direction vector and a northern direction on a horizontal plane, and is, for example, a clockwise angle with respect to the northern direction. The “horizontal plane” is a plane which is perpendicular to the vertical direction.

The stride calculator 244 calculates a stride for each of the left and right feet by using a timing signal for the running cycle and the left-right foot flag output from the running detector 242, and velocity information generated by the GPS unit 50, and outputs the stride for each of the left and right feet.

Specifically, the stride calculator 244 integrates a velocity for each sampling cycle At in a period of time from the start of the running cycle to the start of the next running cycle (alternatively, computes a difference between a position at the time when the running cycle is started and a position at the time when the next running cycle is started) so as to calculate and output a stride (an example of an index). Information regarding the calculated stride is written in the storage unit 30 as the stride information 354.

The pitch calculation section 246 performs a process of calculating the number of steps for one minute by using the timing signal for the running cycle output from the running detector 242, and outputting the number of steps as a running pitch (an example of an index). In other words, the pitch calculator 246 computes the number of steps per second, for example, by taking an inverse number of the running cycle, and calculates the number of steps (=running pitch) for one minute by multiplying the number of steps per second by 60. Information regarding the calculated running pitch is written to the storage unit 30 as the running pitch information 355.

### 1-5-1. Flow in Processing Unit

FIG. 6 is a flowchart illustrating examples of procedures of an exercise analysis process performed by the processing unit 20 of the exercise analysis apparatus 2 during running of the user. The processing unit 20 of the exercise analysis apparatus 2 performs the exercise analysis process (an example of a physical activity information presenting method) according to the procedures of the flowchart illustrated in FIG. 6 by executing the exercise analysis program 300 (an example of a physical activity information presenting program) stored in the storage unit 30.

As illustrated in FIG. 6, the processing unit 20 waits for a measurement starting command to be received (N in step S10), activates the GPS unit 50 so as to cause the GPS unit 50 to acquire GPS data if the measurement starting command is received (Yin step S10), and adds the GPS data to the GPS data table 320 (step S30).

Next, the processing unit 20 performs data processing so as to generate output information during running, and transmits the output information during running to the display apparatus 3 (step S40). The output information during running is updated in real time during running of the user. In the present specification, the “real time” indicates that processing on information is performed whenever the information is generated, and thus a timing at which the information is generated does not completely match a timing at which the information is processed. In other words, the “real time” in the present specification also includes a case where some time lag occurs.

The processing unit 20 repeatedly performs processes in steps S30 and the subsequent steps whenever the sampling cycle At elapses from acquisition of the previous sensing data (Y in step S60) until a measurement stopping command is received (N in step S60 and N in step S70). If the measurement stopping command is received (Y in step S70), the processing unit 20 generates output information after running and transmits the output information after running to the display apparatus 3 (step S80), and finishes the exercise analysis process.

The output information after running is information for displaying respective numerical values such as a running distance from the start to the goal, a running time from the start to the goal, an elevation difference between the start position and the goal, an average velocity from the start to the goal, an average value (average pitch) of running pitches from the start to the goal, an average value (average stride) of strides from the start to the goal, and an average value (average left-right balance) of left-right difference ratios from the start to the goal, on the display apparatus 3.

### 1-5-2. Flow of Data Processing

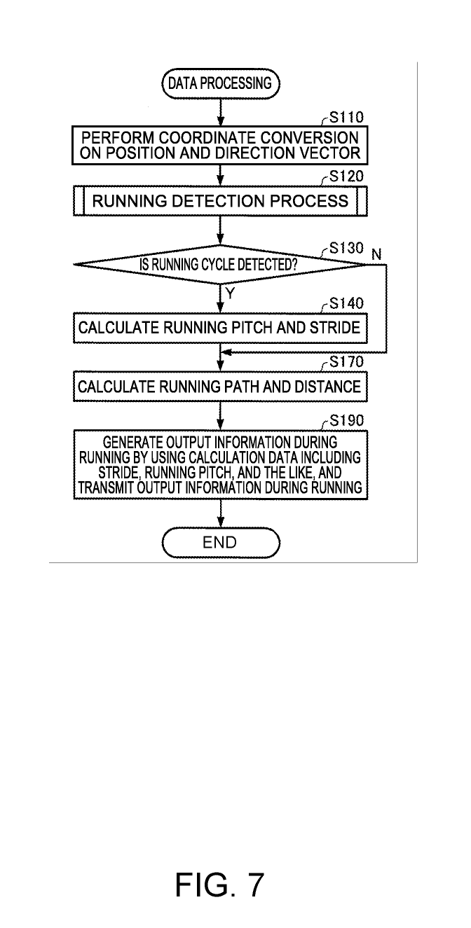

FIG. 7 is a flowchart illustrating examples of procedures of the data processing (the process in step S40 in FIG. 6).

As illustrated in FIG. 7, first, the processing unit 20 coordinate-converts the position information and the direction vector information included in the GPS data acquired in step S30 in FIG. 6 (step S110). This coordinate conversion is performed by the processing unit 20 as the above-described coordinate conversion portion 250.

Next, the processing unit 20 performs a running detection process (step S120). Examples of procedures of the running detection process will be described later.

Next, in a case where a running cycle is detected through the running detection process (step S120) (Y in step S130), the processing unit 20 computes a running pitch and a stride (step S140). The running pitch is computed by the processing unit 20 as the pitch calculator 246, and the stride is computed by the processing unit 20 as the stride calculator 244. In a case where a running cycle is not detected (N in step S130), the processing unit 20 does not perform the process in step S140.

Next, the processing unit 20 computes a running path on the basis of the position (and history of the position), and integrates the velocity so as to compute a running distance (step S170). The running path is calculated by the processing unit 20 as the running path calculation portion 271.

The processing unit 20 generates output information during running by using information such as the velocity, the position, the running path, the stride, and the running pitch, and transmits the output information during running to the display apparatus 3 (step S190). The output information during running is information for displaying respective numerical values of the running velocity, the running pitch, the stride, the running position, the running path from the start position, and the running distance from the start position, and the like, on the display apparatus 3 in real time during running of the user.

The processing unit 20 performs the data processing (the processes in steps S110 to S190) whenever GPS data is acquired in step S30 in FIG. 6.

### 1-5-3. Flow of Running Detection Process

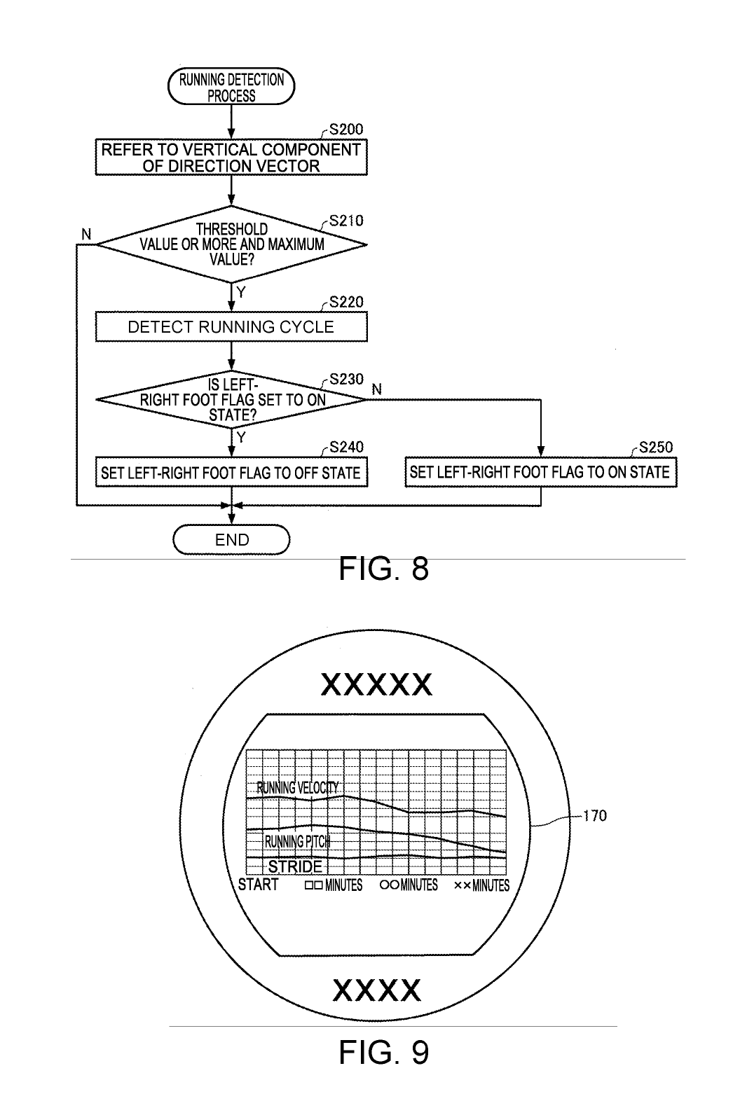

FIG. 8 is a flowchart illustrating examples of procedures of the running detection process (the process in step S120 in FIG. 7). The processing unit 20 performs the running detection process according to the procedures of the flowchart illustrated in FIG. 8. The running detection process is performed by the processing unit 20 as the running detector 242.

As illustrated in FIG. 8, the processing unit 20 refers to a vertical component of the direction vector information coordinate-converted in step S110 in FIG. 7 (step S200). The coordinate-converted direction vector information has an x axis component (northern component), a y axis component (eastern component), and a z axis component (a component in the gravitational direction), and thus the z axis component thereof corresponds to the vertical component of the direction vector information.

Next, in a case where the vertical component referred to in step S200 has a value which is equal to or greater than the threshold value and is the maximum value (Y in step S210), the processing unit 20 detects a running cycle at this timing (generates a timing signal) (step S220).

If the left-right foot flag is set to an ON state (Y in step S230), the processing unit 20 sets the left-right foot flag to an OFF state (step S240), and if the left-right foot flag is not to an ON state (N in step S230), the processing unit 20 sets the left-right foot flag to an ON state (step S250), and finishes the running detection process. In a case where the vertical component of the direction vector information has a value which is smaller than the threshold value or is not the maximum value (N in step S210), the processing unit 20 does not perform the processes in step S220 and the subsequent steps.

### 1-6-1. Example of Display Image During Running

FIG. 9 illustrates an example of a screen displayed on the display unit 170 of the display apparatus 3 during running of the user. In the example illustrated in FIG. 9, time-series graphs are displayed in which a transverse axis expresses time from the start of running, and a longitudinal axis expresses numerical values of respective items of a “running velocity”, “running pitch”, and a “stride”. The graphs of the respective items in FIG. 9 are updated during running of the user in real time. A numerical value of another item may be displayed, and the graph may be scrolled, in response to the user's operation. An item displayed on the screen in FIG. 9 may be an item (for example, an item within a reference range, or items other than a reference item) satisfying a predetermined condition, may be an item whose notification is performed in a sound or the like, and may be an item designated in advance by the user. Instead of the screen displaying the graphs as in FIG. 9, a screen (not illustrated) displaying numerical values of the items may be displayed. Switching between the screen displaying the graphs and the screen displaying the numerical values may be performed in response to the user's input operation.

The user is running while viewing the screen as illustrated in FIG. 9 so as to check the present running state, and can thus be continuously running, for example, while being aware of the way of running which causes the numerical value of each item to become better or the way of running which causes an item whose numerical value is low to be improved, or while objectively recognizing a fatigue state.

1-6-2. Example of display screen after running

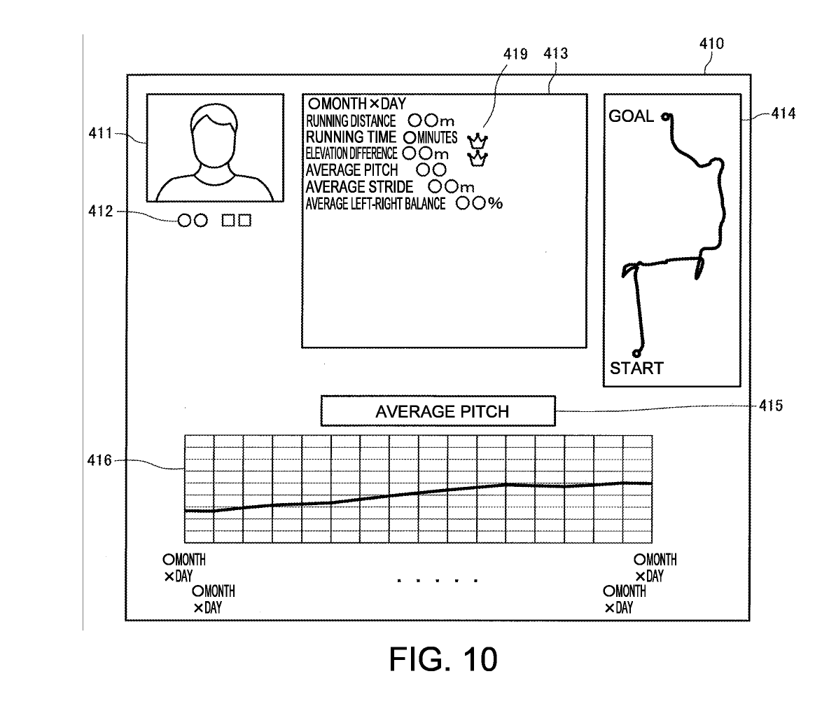

FIG. 10 illustrates an example of a screen displayed on the display unit 170 of the display apparatus 3 after running of the user. The screen illustrated in FIG. 10 displays a large amount of information, and thus may be displayed on the exercise analysis apparatus 2 or an information terminal (a smart phone, a PC, a tablet PC, or the like) which can communicate with the display apparatus 3, instead of the display apparatus 3.

In the example illustrated in FIG. 10, a screen 410 (first page) includes a user image 411 and a user name 412 which are registered in advance by the user, a summary image 413 displaying an analysis result of running, a running path image 414 displaying a running path from the start to the goal, an item name 415 of an item selected by the user, and time-series data 416 thereof.

The summary image 413 includes respective numerical values of the date on which the running is performed, a “running distance”, a “running time”, an “elevation difference (between the start and the goal)”, an “average pitch (an average value of running pitches)”, an “average stride (an average value of strides)”, and an “average left-right balance (an average value of left-right difference ratios)”.

The left-right difference ratio is an index indicating to what extent there is a difference between the left and right parts of the body with respect to each item of the running pitch and the stride, and is assumed to indicate to what extent a left leg is deviated relative to a right leg. The left-right difference ratio is computed as the left-right difference ratio=(numerical value of left leg/numerical value of right leg×100) (%), and the numerical value is a numerical value of each of the running pitch and the stride. The left-right difference ratio also includes an average value or a variance of the numerical values.

In the summary image 413, a predetermined mark 419 is added beside an item whose numerical value is better than a reference value. In the example illustrated in FIG. 10, the mark 419 is added to the “running time” and the “elevation difference”. A predetermined mark may be added to an item whose numerical value is worse than a reference value, or an item whose improvement ratio is higher or lower than a reference value. An item to be added with the mark is selected by the processing unit 20, and an instruction for the item is given to the display apparatus 3.

The running path image 414 is an image which displays a running path from the start point to the goal point. Information regarding the image of the running path is generated by the processing unit 20 and is transmitted to the display apparatus 3.

The item name 415 indicates an item selected by the user from among the items included in the summary image 413, and the time-series data 416 generates numerical values of the item indicated by the item name 415 as a graph in a time series. In the example illustrated in FIG. 10, the “average pitch” is selected, and a time-series graph is displayed in which a transverse axis expresses the running date, and a longitudinal axis expresses a numerical value of the average pitch.

By checking the attainments of the running (evaluation of the running) while viewing the whole analysis screen illustrated in FIG. 10, the user can recognize an advantage or a disadvantage of the user's running way, and can practice the running way for improving running attainments or the running way for improving a running state in the next running and thereafter.

1-7. Appendix of first embodiment

The processing unit 20 of the first embodiment performs comparison between the user's index and another person's index, comparison between the user's index and a reference, comparison between indexes obtained on different dates, and the like in order to evaluate the user's running (FIGS. 9 and 10), but may perform comprehensive evaluation (scoring) for the user's running skill on the basis of the user's two or more indexes.

The evaluation (scoring) may be performed, for example, as a stride becomes larger, a running skill becomes higher (a score becomes higher); as a velocity increases, a running skill becomes higher (a score becomes higher); and as a running pitch becomes higher, a running skill becomes higher (a score becomes higher).

For example, the processing unit 20 of the first embodiment may calculate and display indexes such as the number of accumulated steps and the extent of running dynamics from the start to the goal on the basis of a temporal change in a vertical component of the direction vector information.

The processing unit 20 of the first embodiment may evaluate a running skill by combining data output from the GPS unit 50 or data (for example, at least one of an elevation, a velocity, and a pulse rate) obtained by other units with at least one of the data described in the embodiment.

For example, the processing unit 20 of the first embodiment may compute a load applied to the user's body by using an inertial sensor, a pulse sensor, or the like, and may perform evaluation that a running skill becomes higher as the load is reduced.

In the system of the first embodiment, the exercise analysis apparatus 2 is mounted on the user's waist, but may be mounted on one arm of the user. In this case, the exercise analysis apparatus 2 can measure an arm swing cycle of the user in the same manner as in the measurement of a running cycle of the user, and can thus obtain a running pitch and a stride on the basis of the measured arm swing cycle.

### 2. Second Embodiment

2-1. Differences from First Embodiment

Hereinafter, a second embodiment will be described. The second embodiment is an embodiment of the exercise analysis system 1. Here, a description will be made focusing on differences from the first embodiment. The exercise analysis system 1 of the second embodiment is applied to skiing (an example of physical activity) accompanied by turns. If the number of short turns per second is 3 Hz, the number of positioning computations per second is set to be, for example, 6 Hz or higher, and the exercise analysis apparatus 2 is mounted on, for example, the waist of the user.

An outline and a configuration of the exercise analysis system 1 of the second embodiment are the same as the outline (FIG. 1) and the configuration (FIG. 2) in the first embodiment, but some operations of the processing unit 20 are different from the operations of the processing unit 20 of the first embodiment.

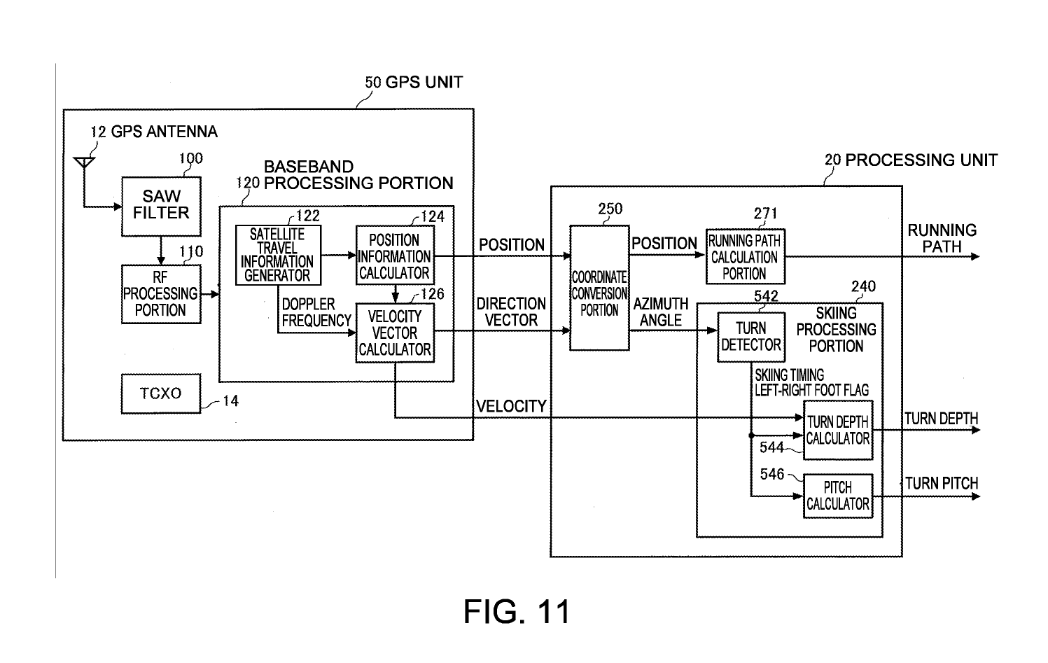

FIG. 11 is a functional block diagram illustrating a configuration example of a GPS unit and a processing unit in the second embodiment. In FIG. 11, the same constituent elements as the constituent elements illustrated in FIG. 3 are given the same reference numerals as the reference numerals in FIG. 3.

As illustrated in FIG. 11, a skiing processing portion 240a of the second embodiment corresponds to including a turn detector 542, a turn depth calculator 544, and a pitch calculator 546 instead of the running detector 242, the stride calculator 244, and the pitch calculator 246 in the running processing portion 240 of the first embodiment. However, the skiing processing portion 240a of the second embodiment may have a configuration in which some of the constituent elements illustrated in FIG. 11 are deleted, or other constituent elements may be added thereto.

The turn detector 542 performs a process of detecting a turn cycle of the user by using the velocity vector information. In addition, “detection of a turn cycle” mentioned here indicates detecting a predetermined timing within the turn cycle. The predetermined timing may be a timing of starting a turn, may be a timing of finishing the turn, and may be a timing at which the user takes a predetermined attitude in a period of time during the turn.

Typically, during skiing accompanied by turns, an attitude of the user periodically changes (every two turns (two turns such as left and right turns)), a direction vector (indicated by the direction vector information) also periodically changes. Therefore, body motion due to skiing is an example of periodic body motion.

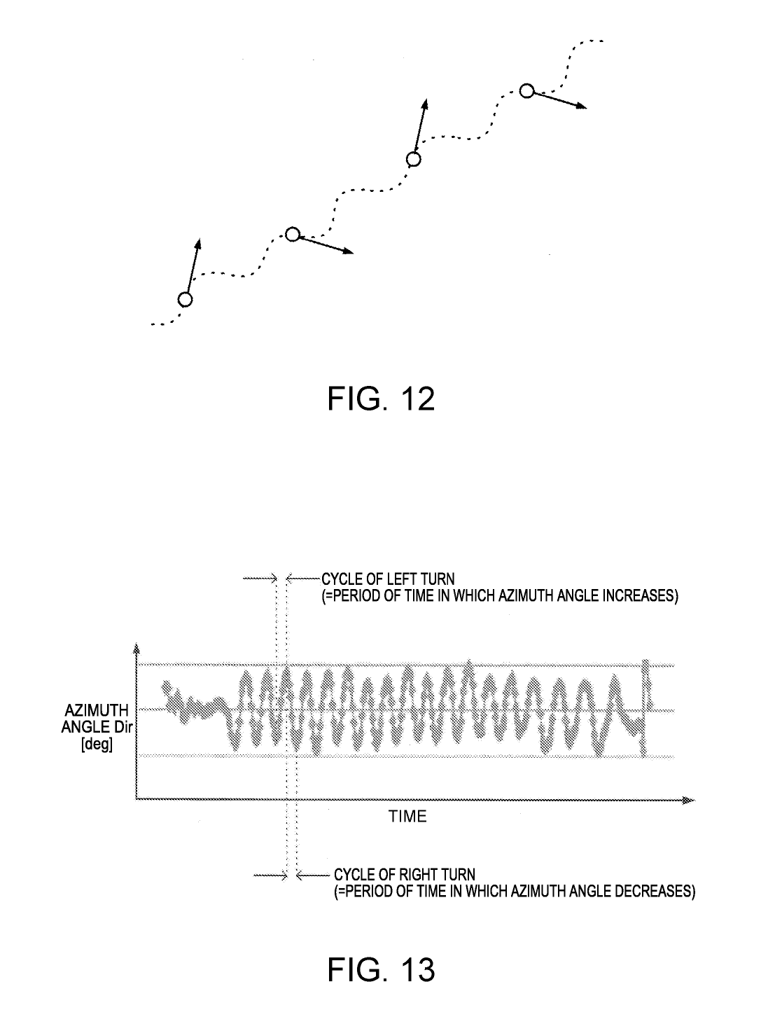

Here, when the direction vector is viewed from the right above of the user (from the top in a vertical direction), as illustrated in FIG. 12, the direction vector temporally changes. Focusing on an azimuth angle (which is an angle formed between the direction vector and a northern direction on a horizontal plane, here, assumed to be a clockwise angle with respect to the northern direction, and is an example of a horizontal component of a movement direction) of the direction vector, the azimuth angle greatly changes over time as illustrated in FIG. 13. In FIG. 13, a transverse axis expresses time, and a longitudinal axis expresses an azimuth angle of the direction vector. A cycle length of a temporal change in the azimuth angle is time required in two turns (that is, one right turn and one left turn) of the user.

Therefore, the azimuth angle of the direction vector reflects turns of the user (horizontal motion), and thus a period of time in which the azimuth angle changes from an increasing tendency (decreasing tendency) to a decreasing tendency (or increasing tendency) next corresponds to a period of time of one turn (a right turn or a left turn). The left turn and the right turn are alternately repeated.

Therefore, the turn detector 542 of the present embodiment detects a cycle of the right turn whenever the azimuth angle of the direction vector changes from an increasing tendency to a decreasing tendency, and detects a cycle of the left turn whenever the azimuth angle of the direction vector changes from a decreasing tendency to an increasing tendency. In other words, the turn detector 542 outputs a timing signal indicating detection of the turn cycle and a left-right turn flag (for example, an ON flag for the right turn) indicating a right turn cycle whenever the azimuth angle of the direction vector changes from an increasing tendency to a decreasing tendency, and outputs a timing signal indicating detection of the turn cycle and a left-right turn flag (for example, an OFF flag for the left turn) indicating a left turn cycle whenever the azimuth angle of the direction vector changes from a decreasing tendency to an increasing tendency.

The turn depth calculator 544 performs a process of calculating and outputting a turn depth for each of left and right turns by using the timing signals for the turn cycles and the left-right turn flags output from the turn detector 542, and velocity information generated by the GPS unit 50.

Specifically, the turn depth calculator 544 integrates a velocity for each sampling cycle At in a period of time from the start of the turn cycle to the start of the next turn cycle (alternatively, computes a difference between a position at the time when the turn cycle is started and a position at the time when the next turn cycle is started) so as to calculate a turn distance. The turn depth calculator 544 calculates a change amount of the azimuth angle as a turn angle in the period of time from the start of the turn cycle to the start of the next turn cycle. The turn depth calculator 544 calculates and outputs, as a turn depth (an example of an index), a value in which both of the length of the turn distance and the magnitude of the turn angle are reflected (in other words, a value of the turn depth becomes greater as the turn distance is lengthened, and becomes greater as the turn angle is increased). Information regarding the calculated turn depth is written in the storage unit 30 as turn depth information (in FIG. 2, the turn depth information is not illustrated).

The pitch calculator 546 performs a process of calculating the number of turns for one minute by using the timing signals for the turn cycles output from the turn detector 542, and outputting the number of turns as a turn pitch (an example of an index). In other words, the pitch calculator 546 computes the number of turns per second, for example, by taking an inverse number of the turn cycle, and calculates the number of turns (=turn pitch) for one minute by multiplying the number of turns per second by 60. Information regarding the calculated turn pitch is written to the storage unit 30 as the turn pitch information (in FIG. 2, the turn pitch information is not illustrated).

### 2-2. Flow in Processing Unit

In the present embodiment, procedures of an exercise analysis process performed by the processing unit 20 of the exercise analysis apparatus 2 during skiing (during sliding) are fundamentally the same as the procedures described in the first embodiment.

However, the processing unit 20 of the present embodiment calculates the turn pitch instead of the running pitch, calculates the turn depth instead of the stride, calculates an average value of the turn pitches as an average pitch, and calculates an average turn depth (an average value of the turn depths) instead of the average stride. The calculation of the turn depth is performed by the processing unit 20 as the turn depth calculator 544, and the calculation of the turn pitch is performed by the processing unit 20 as the pitch calculator 546.

Output information during skiing which is transmitted from the processing unit 20 of the present embodiment to the display apparatus 3 is information for displaying (updating) respective numerical values of the skiing velocity, the turn pitch, the turn depth, the skiing position, the skiing path from the start position, and the skiing distance from the start position, and the like, on the display apparatus 3 in real time during skiing (during sliding) of the user.

Output information after skiing which is transmitted from the processing unit 20 of the present embodiment to the display apparatus 3 is information for displaying respective numerical values such as a skiing distance from the start to the goal, a skiing time from the start to the goal, an elevation difference between the start position and the goal, an average velocity from the start to the goal, an average value (average pitch) of turn pitches from the start to the goal, an average value (average turn depth) of turn depths from the start to the goal, and an average value (average left-right balance) of left-right difference ratios from the start to the goal, on the display apparatus 3.

The left-right difference ratio is an index indicating to what extent there is a difference between the left and right parts of the body with respect to each item of the turn pitch and the turn depth, and indicates to what extent a left turn is different from a right turn. The left-right difference ratio is computed as the left-right difference ratio=(numerical value of left turn/numerical value of right turn×100) (%), and the numerical value is a numerical value of each of the turn pitch and the turn depth. The left-right difference ratio also includes an average value or a variance of the numerical values.

### 2-3. Display Screen

In the present embodiment, a screen displayed on the display unit 170 is fundamentally the same as the screen (FIGS. 9 and 10) described in the first embodiment. However, in the present embodiment, a turn pitch is displayed instead of a running pitch; the number of accumulated turns is displayed instead of the number of accumulated steps; a turn depth is displayed instead of a stride; an average value of turn pitches is displayed as an average pitch; and an average turn depth is displayed instead of an average stride.

### 2-4. Appendix of Second Embodiment

In the second embodiment, comparison between the user's index and another person's index, comparison between the user's index and a reference, comparison between indexes obtained on different dates, comparison (ranking) between indexes of a plurality of users, and the like are performed in order to evaluate skiing accompanied by turns, but comprehensive evaluation (scoring) for the user's skiing skill may be performed.

The evaluation (scoring) may be performed, for example, as a turn depth becomes larger, a skiing skill becomes higher (a score becomes higher); as a velocity increases, a skiing skill becomes higher (a score becomes higher); and as a turn pitch becomes higher, a skiing skill becomes higher (a score becomes higher).

For example, the processing unit 20 of the second embodiment may calculate and display indexes such as the number of accumulated turns, the shape of a turn, and the extent of skiing (sliding) dynamics from the start to the goal on the basis of a temporal change in an azimuth angle of the direction vector.

The processing unit 20 of the second embodiment may evaluate a skiing skill by combining data output from the GPS unit 50 or data (for example, at least one of an elevation, a velocity, and a pulse rate) obtained by other units with at least one of the data described in the embodiment.

For example, the processing unit 20 of the second embodiment may compute a load applied to the user's body by using an inertial sensor, a pulse sensor, or the like, and may perform evaluation that a skiing skill becomes higher as the load is reduced.

In the system of the second embodiment, the exercise analysis apparatus 2 is mounted on the user's waist, but may be mounted on one arm of the user. In this case, the exercise analysis apparatus 2 can measure an arm swing cycle (stock swing cycle) of the user in the same manner as in the measurement of a turn cycle of the user, and can thus obtain a turn pitch and a turn depth on the basis of the measured stock swing cycle.

In a case where the processing unit 20 of the second embodiment does not use a vertical component of the direction vector, the direction vector output from the GPS unit 50 may be a vector (a two-dimensional vector in a horizontal plane) not including a vertical component.

In this case, since the order of necessary velocity vectors is reduced by one, the velocity vector calculator 126 of the GPS unit 50 may use respective pieces of information for three GPS satellites to calculate velocity vectors at the time of starting reception, and may then use respective pieces of information for GPS satellites of less than three to calculate velocity vectors.

A single exercise analysis apparatus 2 having both of the function of the exercise analysis apparatus 2 of the second embodiment and the function of the exercise analysis apparatus 2 of the first embodiment may be configured. In this case, for example, the function in the first embodiment may be installed in the exercise analysis apparatus 2 as a “running mode”, and the function in the second embodiment may be installed in the exercise analysis apparatus 2 as a “skiing mode”.

### 3. Appendix of First Embodiment or Second Embodiment

The processing unit 20 of the first embodiment or the second embodiment may change a cycle (a time interval in which positioning computation is performed) of positioning computation in the GPS unit 50 according to an application of the exercise analysis apparatus 2 (according to a speed at which a direction changes).

For example, a speed at which a direction of the user's body changes when skiing accompanied by turns or running is steeper than a speed at which a direction of the user's body changes in walking. The processing unit 20 may set a finer time interval of positioning computation when the exercise analysis apparatus 2 is applied to skiing accompanied by turns or running than a time interval of positioning computation when the exercise analysis apparatus 2 is applied to walking.

For example, since a speed at which a direction of the user's body changes differs depending on whether the exercise analysis apparatus 2 is applied to long-distance running or short-distance running even in the same running, the processing unit 20 may much more finely adjust a time interval of positioning computation. A running pitch in long-distance running is at most 3 Hz, a running pitch in short-distance running is about 5 Hz, and a short turn pitch when skiing is at most about 3 Hz. In any case, a time interval of positioning computation is preferably set to be ½ or less of a time interval in which a direction of the user's body changes.

The GPS unit 50 of the first embodiment or the second embodiment uses a Doppler frequency to calculate a velocity vector (direction vector), but may use history (that is, a movement path) of positions acquired through positioning computation.

A velocity vector at a certain point can be uniformly obtained by using a Doppler frequency detected at the point. Therefore, if a velocity vector is calculated by using a Doppler frequency detected at one point, time required in calculation can be reduced compared with a case where a velocity vector is calculated by using data detected two or more points.

In the first embodiment or the second embodiment, an inertial sensor (an acceleration sensor, an angular velocity sensor, or the like) is not mounted in the exercise analysis apparatus 2, but may be mounted therein. In this case, the processing unit 20 may correct data generated by the GPS unit 50 on the basis of outputs from the inertial sensor, and may correct outputs from the inertial sensor on the basis of data generated by the GPS unit 50 (this correction is, for example, bias correction).

In the first embodiment or the second embodiment, in a case where the exercise analysis apparatus 2 is mounted on one arm of the user, the exercise analysis apparatus 2 may be formed of a watch type (wrist mounted type) apparatus. In a case where the exercise analysis apparatus 2 is formed of a watch type apparatus, the exercise analysis apparatus 2 and the display apparatus 3 (refer to FIG. 1) may be integrated into a single apparatus. In other words, the function of the exercise analysis apparatus 2 may be installed in the wrist mounted type display apparatus 3.

The processing unit 20 of the first embodiment or the second embodiment uses outputs from the GPS unit 50 to calculate position coordinates of the exercise analysis apparatus 2, but may use at least one or a combination of two or more outputs from the GPS unit 50, a geomagnetic sensor, an air pressure sensor, and an inertial sensor.

The exercise analysis system 1 of the first embodiment or the second embodiment is applicable to periodic body motion other than running or skiing, for example, walking, trail running, climbing, dieting, rehabilitation, speed skating, different types of skiing (for example, cross-country and mogul skiing), bicycling, a hand-rowing boat, dancing, fighting sports, sleeping (respiratory motion or the like), swimming, and triathlon.

For example, a kicking timing in speed skating may be detected in the same manner as in detection of a kicking timing in running.

The exercise analysis system 1 of the first embodiment or the second embodiment is applicable to exercise which may not include periodic body motion, for example, climbing, skating, golf, baseball, soccer, biking, motor sports, boating (motor boating), yachting, paragliding, kiting, and dog sledding, in addition to skiing (ski jumping), tennis, dieting, and rehabilitation.

For example, assuming that the number of body motions (the number of passing through bumps) per second in mogul skiing is 10 Hz, in a case where the exercise analysis system 1 is applied to mogul skiing, the number of positioning computations per second is set to, for example, 20 Hz or more. Since a movement speed of a user in ski jumping or a movement speed of a ball in soccer is higher than a movement speed of a user in many other exercises, in a case where the exercise analysis system 1 is applied to ski jumping or soccer, the number of positioning computations per second is set to a great value, for example, 20 Hz.

Hereinafter, a description will be made of several examples of the kind of exercise to which the system of the first embodiment or the second embodiment is applicable, an index useful for the exercise, and a mounting location of the exercise analysis apparatus 2.

### (1) Skating

Indexes: relationship among kicking direction, timing, left-right difference, and velocity

Mounting location: user's body

(2) Ski jumping

Indexes: combination of direction of jumping out of user's body (taking off), a flying direction (difference from free fall), timing, velocity, and elevation

Mounting location: user's body

(3) Ball games such as soccer and rugby

Indexes: flying ball direction, swing of non-rotating ball, influence of wind, and the like

Mounting location: ball

(4) Ball games such as soccer and rugby

Indexes: user's amount of motion

Mounting location: user's body

(5) Throwing competitions such as javelin throw, shot put, discus throw, and hammer throw

Indexes: combination of flying direction of throwing tool, taking-off timing, velocity, and elevation

Mounting location: throwing tool

(6) Jump, long jump, high jump, and pole vault

Indexes: combination or the like of direction of user's torso motion, timing, velocity, and elevation

Mounting location: user's body

### (7) Bicycling

Indexes: pedaling pitch, the number of times of pedaling, and the like Mounting location: user's foot, pedal, or the like

### (8) Swimming

Indexes: stroke, rolling, and the like

Mounting location: user's body or the like

The system of the first embodiment or the second embodiment uses a satellite signal and may thus be considerably appropriate for outdoor sports which have better condition of receiving satellite signals.

### 4. Operations and Effects of First Embodiment or Second Embodiment

(1) An electronic apparatus (exercise analysis apparatus 2) according to the first embodiment or the second embodiment includes the processing unit 20 which presents either or both of indexes (a running pitch, the number of accumulated steps, a stride, a turn pitch, the number of accumulated turns, a turn depth, and the like) and evaluations (FIGS. 9 and 10) regarding physical activity (running, skiing, or the like) of a user causing a directional change by using movement direction information (direction vector) of the user calculated on the basis of a satellite signal (GPS satellite signal).

In other words, the processing unit 20 uses the movement direction information (direction vector) based on the satellite signal (GPS satellite signal) in order to present either or both of the indexes (a running pitch, the number of accumulated steps, a stride, a turn pitch, the number of accumulated turns, a turn depth, and the like) and the evaluations (FIGS. 9 and 10). The movement direction information (direction vector) based on the satellite signal (GPS satellite signal) indicates a movement direction of the electronic apparatus (exercise analysis apparatus 2) viewed from a positioning satellite (GPS satellite) with predetermined accuracy without being influenced by an attitude of the electronic apparatus (exercise analysis apparatus 2). Therefore, the user can understand features of the physical activity (running, skiing, or the like) thereof causing a directional change on the basis of either or both of the indexes and the evaluations presented by the processing unit 20.

(2) In the electronic apparatus (exercise analysis apparatus 2) according to the first embodiment or the second embodiment, the physical activity of the user includes periodic body motion (for example, running or turns) of the user.

Therefore, the user can understand features of the periodic body motion (for example, running or turns) of the user.

(3) In the electronic apparatus (exercise analysis apparatus 2) according to the first embodiment or the second embodiment, the periodic body motion includes at least one of walking and running performed by the user.

Therefore, the user can understand features of at least one of walking and running of the user.

(4) In the electronic apparatus (exercise analysis apparatus 2) according to the first embodiment or the second embodiment, the indexes include at least one of the number of steps and a stride of the user.

Therefore, the user can understand the number of steps or the stride as a feature of walking or running of the user.

(5) In the electronic apparatus (exercise analysis apparatus 2) according to the first embodiment or the second embodiment, the movement direction information (direction vector) includes a vertical component of a movement direction of the user.

Vertical motion (one of the motions caused by walking, running, or the like) of the user is reflected in the vertical component of the movement direction of the user. Therefore, the processing unit 20 can present an index or an evaluation regarding the vertical motion with high accuracy on the basis of the movement direction information (direction vector).

(6) In the electronic apparatus (exercise analysis apparatus 2) according to the first embodiment or the second embodiment, the periodic body motion includes the user's turns when skiing.

Therefore, the user can understand features of the user's turns when skiing.

(7) In the electronic apparatus (exercise analysis apparatus 2) according to the first embodiment or the second embodiment, the indexes include at least one of the number of turns and a turn depth of the user.

Therefore, the user can understand at least one of the number of turns and the turn depth which is a feature regarding skiing of the user.

(8) In the electronic apparatus (exercise analysis apparatus 2) according to the first embodiment or the second embodiment, the movement direction information (direction vector) includes a horizontal component of the movement direction of the user.

Horizontal motion (one of the motions caused by turns when skiing) of the user is reflected in the horizontal component of the movement direction of the user. Therefore, the processing unit 20 can present an index or an evaluation regarding the horizontal motion with high accuracy on the basis of the movement direction information (direction vector).

(9) In the electronic apparatus (exercise analysis apparatus 2) according to the first embodiment or the second embodiment, the movement direction information (direction vector) is calculated on the basis of a Doppler frequency of the satellite signal.

The movement direction information (direction vector) at a certain point can be directly obtained by using a Doppler frequency of a satellite signal received at the point. Therefore, if movement direction information (direction vector) is calculated by using a Doppler frequency, time required in calculation can be reduced compared with a case where positions are detected at two or more points, and the movement direction information (direction vector) is calculated by using a positional change.

(10) In the electronic apparatus (exercise analysis apparatus 2) according to the first embodiment or the second embodiment, the electronic apparatus (exercise analysis apparatus 2) can be mounted on the user's body.

Therefore, the user can recognize either or both of the indexes and the evaluations even if the user does not hold the electronic apparatus (exercise analysis apparatus 2) with the hand.

(11) A physical activity information presenting method (a method using the exercise analysis program) according to the first embodiment or the second embodiment includes presenting either or both of indexes (a running pitch, the number of accumulated steps, a stride, a turn pitch, the number of accumulated turns, a turn depth, and the like) and evaluations (FIGS. 9 and 10) regarding physical activity (running, skiing, or the like) of a user causing a directional change by using movement direction information (direction vector) of the user calculated on the basis of a satellite signal (GPS satellite signal).

In other words, in the physical activity information presenting method, the movement direction information (direction vector) based on the satellite signal (GPS satellite signal) is used to present either or both of the indexes (a running pitch, the number of accumulated steps, a stride, a turn pitch, the number of accumulated turns, a turn depth, and the like) and the evaluations (FIGS. 9 and 10). The movement direction information (direction vector) based on the satellite signal (GPS satellite signal) indicates a movement direction of the electronic apparatus (exercise analysis apparatus 2) viewed from a positioning satellite (GPS satellite) with predetermined accuracy without being influenced by an attitude of the electronic apparatus (exercise analysis apparatus 2). Therefore, the user can understand features of the physical activity (running, skiing, or the like) thereof causing a directional change on the basis of either or both of the indexes and the evaluations.

(12) A physical activity information presenting program (exercise analysis program) according to the first embodiment or the second embodiment causes a computer (processing unit 20) to present either or both of indexes (a running pitch, the number of accumulated steps, a stride, a turn pitch, the number of accumulated turns, a turn depth, and the like) and evaluations (FIGS. 9 and 10) regarding physical activity (running, skiing, or the like) of a user causing a directional change by using movement direction information (direction vector) of the user calculated on the basis of a satellite signal (GPS satellite signal).

In other words, in the physical activity information presenting program, the movement direction information (direction vector) based on the satellite signal (GPS satellite signal) is used to present either or both of the indexes (a running pitch, the number of accumulated steps, a stride, a turn pitch, the number of accumulated turns, a turn depth, and the like) and the evaluations (FIGS. 9 and 10). The movement direction information (direction vector) based on the satellite signal (GPS satellite signal) indicates a movement direction of the electronic apparatus (exercise analysis apparatus 2) viewed from a positioning satellite (GPS satellite) with predetermined accuracy without being influenced by an attitude of the electronic apparatus (exercise analysis apparatus 2). Therefore, the user can understand features of the physical activity (running, skiing, or the like) thereof causing a directional change on the basis of either or both of the indexes and the evaluations.

### 5. Application Examples of Embodiments

The invention is not limited to the above-described embodiments, and may be variously modified within the scope of the spirit of the invention.

For example, the processing unit 20 of the above-described embodiments presents both of the indexes (a running pitch, the number of accumulated steps, a stride, a turn pitch, the number of accumulated turns, a turn depth, and the like) and the evaluations (FIGS. 9 and 10) regarding the physical activity of the user, but may present only the indexes, and may present only the evaluations. The processing unit 20 may present only some of the plurality of indexes described in the embodiments, and may present only some of the plurality of evaluations described in the embodiments. The processing unit 20 may present combinations of some or all of the plurality of indexes described in the embodiments and some or all of the plurality of evaluations described in the embodiments.

For example, at least some of the two or more processes which are performed by the processing unit 20 as serial processes may be performed as parallel processes. At least some of the two or more processes which are performed by the processing unit 20 as parallel processes may be performed as serial processes.

In the above-described embodiments, at least some of the functions of the exercise analysis apparatus 2 may be installed on the display apparatus 3 side, and at least some of the functions of the display apparatus 3 may be installed on the exercise analysis apparatus 2 side.

In the above-described embodiments, some (excluding the reception function of the GPS unit) of the functions of the exercise analysis apparatus 2 or at least some of the functions of the display apparatus 3 may be installed in an information terminal such as a smart phone which can communicate with the exercise analysis apparatus 2 or the display apparatus 3.

Some of the functions of the exercise analysis apparatus 2 or the display apparatus 3 may be installed in a network server which provides information to a user of the exercise analysis apparatus 2. In this case, the exercise analysis apparatus 2 or the display apparatus 3 may directly perform communication with the network server, and may perform communication with the network server via an information terminal of the user.

Well-known functions of a smart phone, for example, a camera function, a call function, a sensing function regarding exercise (for example, an inertial sensor such as an acceleration sensor or an angular velocity sensor) may be installed in the exercise analysis apparatus or the display apparatus of the above-described embodiments.

Sensors having a sensing function regarding physical activity, for example, a temperature sensor, a humidity sensor, and a pulse sensor may be mounted in the exercise analysis apparatus or the display apparatus of the above-described embodiments.

The exercise analysis apparatus or the display apparatus of the above-described embodiments may be configured as various types of portable apparatuses such as a wrist type electronic apparatus, an earphone type electronic apparatus, a ring type electronic apparatus, a pendant type electronic apparatus, an electronic apparatus mounted on a sport apparatus and used, a smart phone, and a head mounted display (HMD).

The exercise analysis apparatus or the display apparatus of the above-described embodiments mainly performs a notification of information for a user through image display, but may perform a notification through sound output or vibration, and may perform a notification through a combination of at least two of the image display, the sound output and the vibration.

In the above-described embodiments, as a global satellite positioning system, a global positioning system (GPS) is used, but a global navigation satellite system (GNSS) may be used. For example, one or two or more of satellite positioning systems such as a European geostationary-satellite navigation overlay service (EGNOS), a quasi zenith satellite system (QZSS), a global navigation satellite system (GLONASS), GALILEO, a BeiDou navigation satellite system (BeiDou) may be used. As at least one of the satellite positioning systems, a satellite-based augmentation system (SBAS) such as European geostationary-satellite navigation overlay service (EGNOS) or a wide area augmentation system (WAAS) may be used.

The above-described embodiments and modification examples are only examples, and the invention is not limited thereto. For example, the respective embodiments and the respective modification examples may be combined with each other as appropriate.

The invention includes substantially the same configuration (for example, a configuration in which functions, methods, and results are the same, or a configuration in which objects and effects are the same) as the configuration described in the embodiments. The invention includes a configuration in which an inessential part of the configuration described in the embodiments is replaced with another part. The invention includes a configuration which achieves the same operation and effect or a configuration capable of achieving the same object as in the configuration described in the embodiments. The invention includes a configuration in which a well-known technique is added to the configuration described in the embodiments.

What is claimed is:

1. An electronic apparatus comprising:
a processing unit that presents either or both of indexes and evaluations regarding physical activity of a user causing a directional change by using movement direction information of the user calculated on the basis of a satellite signal.

2. The electronic apparatus according to claim 1,
wherein the physical activity includes periodic body motion of the user.

3. The electronic apparatus according to claim 2,
wherein the periodic body motion includes at least one of walking and running performed by the user.

4. The electronic apparatus according to claim 1,
wherein the indexes include at least one of the number of steps and a stride of the user.

5. The electronic apparatus according to claim 4,
wherein the movement direction information includes a vertical component of a movement direction of the user.

6. The electronic apparatus according to claim 2,
wherein the periodic body motion includes the user's turns when skiing.

7. The electronic apparatus according to claim 6,
wherein the indexes include at least one of the number of turns and a turn depth of the user.

8. The electronic apparatus according to claim 1,
wherein the movement direction information includes a horizontal component of a movement direction of the user.

9. The electronic apparatus according to claim 4,
wherein the movement direction information includes a horizontal component of a movement direction of the user.

10. The electronic apparatus according to claim 5,
wherein the movement direction information includes a horizontal component of the movement direction of the user.

11. The electronic apparatus according to claim 6,
wherein the movement direction information includes a horizontal component of the movement direction of the user.

12. The electronic apparatus according to claim 1,
wherein the movement direction information is calculated on the basis of a Doppler frequency of the satellite signal.

13. The electronic apparatus according to claim 1,
wherein the electronic apparatus can be mounted on the user's body.

14. A physical activity information presenting method comprising:
presenting either or both of indexes and evaluations regarding physical activity of a user causing a directional change by using movement direction information of the user calculated on the basis of a satellite signal.

15. The physical activity information presenting method according to claim 14,
wherein the physical activity includes periodic body motion of the user.

16. The physical activity information presenting method according to claim 15,
wherein the periodic body motion includes at least one of walking and running performed by the user.

17. The physical activity information presenting method according to claim 14,
wherein the indexes include at least one of the number of steps and a stride of the user.

18. The physical activity information presenting method according to claim 17,
wherein the movement direction information includes a vertical component of a movement direction of the user.

19. The physical activity information presenting method according to claim 15,
wherein the periodic body motion includes the user's turns when skiing.

20. The physical activity information presenting method according to claim 19,
wherein the indexes include at least one of the number of turns and a turn depth of the user.

21. The physical activity information presenting method according to claim 14,
wherein the movement direction information includes a horizontal component of a movement direction of the user.

22. The physical activity information presenting method according to claim 14,
wherein the movement direction information is calculated on the basis of a Doppler frequency of the satellite signal.

23. A recording medium recording a program causing a computer to:
present either or both of indexes and evaluations regarding physical activity of a user causing a directional change by using movement direction information of the user calculated on the basis of a satellite signal.
